(19) United States
(12) Patent Application Publication
(10) Pub. No.: US 2024/0105969 A1
(43) Pub. Date: Mar. 28, 2024

(54) SEAL MATERIAL FOR ELECTROCHEMICAL REACTION CELL, ELECTROCHEMICAL REACTION CELL CARTRIDGE, AND METHOD OF PRODUCING SEAL MATERIAL FOR ELECTROCHEMICAL REACTION CELL

(71) Applicant: MITSUBISHI HEAVY INDUSTRIES, LTD., Tokyo (JP)

(72) Inventor: Hiroshi Tsukuda, Tokyo (JP)

(73) Assignee: MITSUBISHI HEAVY INDUSTRIES, LTD., Tokyo (JP)

(21) Appl. No.: 18/276,693

(22) PCT Filed: Feb. 21, 2022
(86) PCT No.: PCT/JP2022/006810

§ 371 Date: Aug. 10, 2023

(30) Foreign Application Priority Data
Feb. 22, 2021 (JP) 2021-025909

(51) Int. Cl. H01M 8/0282; H01M 8/0286

(52) U.S. Cl. CPC H01M 8/0282; H01M 8/0286; H01M 2008/1293

(57) ABSTRACT

A seal material for an electrochemical reaction cell separates fuel gas and oxidizing gas in the electrochemical reaction cell. The seal material for an electrochemical reaction cell includes: a plurality of ceramic particles; and a hardener for hardening the plurality of ceramic particles, and has an apparent porosity of 10 to 25%.

### TECHNICAL FIELD

The present disclosure relates to a seal material for an electrochemical reaction cell, an electrochemical reaction cell cartridge, and a method of producing a seal material for an electrochemical reaction cell.

The present application claims priority based on Japanese Patent Application No. 2021-025909 filed on Feb. 22, 2021, the entire content of which is incorporated herein by reference.

### BACKGROUND ART

A fuel cell for generating power by chemical reaction of fuel gas and oxidizing gas has characteristics such as excellent power generation efficiency and environmental responsiveness. Among these, a solid oxide fuel cell (SOFC) uses ceramics such as zirconia ceramics as an electrolyte and generates power by supplying, as fuel gas, a gas such as hydrogen, city gas, natural gas, and gasification gas produced from petroleum, methanol, and carbon-containing raw materials with a gasification facility, and causing reaction in a high-temperature atmosphere of approximately 700° C. to 1,000° C.

The solid oxide fuel cell may be provided with a seal material to prevent unwanted mixing of fuel gas and oxidizing gas. If a function of gas permeation prevention by the seal material is insufficient, the oxidizing gas may penetrate from the oxidizing gas side to the fuel gas side through the seal material and the fuel gas is oxidized, which can cause a decrease in performance such as power generation efficiency.

For example, Patent Document 1 discloses a fuel cell stack that can prevent mixing of fuel gas and oxidizing gas by placing a seal material between a fuel cell for generating power and a current collector member for extracting power generated by the fuel cell. Patent Document 1 describes that a good sealing effect can be obtained when such a seal material contains glass.

### CITATION LIST

### Patent Literature

Patent Document 1: JP2018-55914A

### SUMMARY

### Problems to be Solved

The seal material containing glass provides a good sealing effect, but when a pressure difference occurs between fuel gas and oxidizing gas separated by the seal material, it is easily damaged by the pressure difference. For example, in a fuel cell connected to a gas turbine or the like, the pressure difference can occur between fuel gas and oxidizing gas, causing cracks or other damage to the seal material. Specifically, a fuel cell connected to a gas turbine is operated at a pressure higher than the normal pressure (atmospheric pressure), and the pressure is always controlled by a differential pressure regulating valve to keep the pressure difference between a fuel gas system and an oxidizing gas system approximately constant. Therefore, during startup or load changes, the differential pressure may become excessive compared to normal pressure operation due to a response delay of the differential pressure regulating valve or device malfunction. In Patent Document 1, damage to the seal material is prevented by bending the current collector member which touches the seal material. However, the configuration of the current collector member becomes complex, and there is still a possibility of damage when the pressure difference is large.

At least one embodiment of the present disclosure was made in view of the above, and an object thereof is to provide a seal material for a fuel cell, a fuel cell cartridge, and a method of producing a seal material for a fuel cell whereby it is possible to effectively prevent the occurrence of damage while securing a good leak performance even when a pressure difference occurs between fuel gas and oxidizing gas.

These issues are common not only to cells of a fuel cell but also to other types of cells of a fuel cell. Further, these issues are common not only to cells of a fuel cell but also to electrolytic cells that produce hydrogen by electrolysis of water or steam, electrochemical cells that can both generate power and produce hydrogen, and electrochemical cells for methanation that produce methane from carbon dioxide using produced hydrogen. Herein, single fuel cells and electrochemical cells are collectively referred to as electrochemical reaction cells.

### Solution to the Problems

In order to solve the above-described problems, a seal material for an electrochemical reaction cell according to at least one embodiment of the present disclosure, for separating fuel gas and oxidizing gas in the electrochemical reaction cell, includes: a plurality of ceramic particles; and a hardener for hardening the plurality of ceramic particles, and has an apparent porosity of 10 to 25%.

In order to solve the above-described problems, an electrochemical reaction cell cartridge according to at least one embodiment of the present disclosure includes: at least one electrochemical reaction cell stack including an electrochemical reaction cell; a current collector member for collecting power generated by the at least one electrochemical reaction cell stack; and a seal material for an electrochemical reaction cell according to at least one embodiment of the present disclosure. The seal material for an electrochemical reaction cell is disposed between a fuel gas passage and an oxidizing gas passage of the at least one electrochemical reaction cell stack.

In order to solve the above-described problems, a method of producing a seal material for an electrochemical reaction cell according to at least one embodiment of the present disclosure, for separating fuel gas and oxidizing gas in the electrochemical reaction cell, includes a step of hardening a plurality of ceramic particles with a hardener so as to have an apparent porosity of 10 to 25%.

### Advantageous Effects

At least one embodiment of the present disclosure provides a seal material for an electrochemical reaction cell, an electrochemical reaction cell cartridge, and a method of producing a seal material for an electrochemical reaction cell whereby it is possible to effectively prevent the occurrence of damage while securing a good leak performance even when a pressure difference occurs between fuel gas and oxidizing gas.

### BRIEF DESCRIPTION OF DRAWINGS

FIG. 1 shows one aspect of a cell stack according to an embodiment.

FIG. 2 shows one aspect of an electrochemical reaction cell module according to the present embodiment.

FIG. 3 is a cross-sectional view of one aspect of an electrochemical reaction cell cartridge according to the present embodiment.

FIG. 4A is an example of a microscopic image of a seal material.

FIG. 4B is a schematic diagram schematically showing the internal structure of the seal material shown in FIG. 4A.

FIG. 5 shows the correlation between the relative density of the seal material and the porosity of open pores and closed pores.

FIG. 6 shows verification test results of samples A to D using ceramic particles with different composition ratios.

FIG. 7 is an explanatory diagram of a leak rate measurement test.

FIG. 8 is a flowchart showing one aspect of a method of producing a seal material according to the present embodiment.

### DETAILED DESCRIPTION

Hereinafter, an embodiment of an electrochemical reaction cell, an electrochemical reaction cell cartridge, and a method of producing an electrochemical reaction cell according to the present invention will be described with reference to the drawings.

Hereinafter, for convenience of explanation, the positional relationship of components described using the expressions “upper” and “lower” with respect to the paper indicates the vertically upper side and the vertically lower side, respectively. Further, in the present embodiment, the upper/lower direction on the paper is not necessarily limited to the vertically upper/lower direction, but may correspond to, for example, the horizontal direction perpendicular to the vertical direction if the same effect is obtained in the vertical and horizontal directions.

Further, hereinafter, a cylindrical (tubular) cell stack will be described as an example of a cell stack of solid oxide fuel cells (SOFC), but the present invention is not necessarily limited thereto, and the cell stack may be, for example, a flat cell stack. An electrochemical reaction cell is formed on a substrate, but an electrode (anode or cathode) may be formed thick instead of the substrate to serve as the substrate.

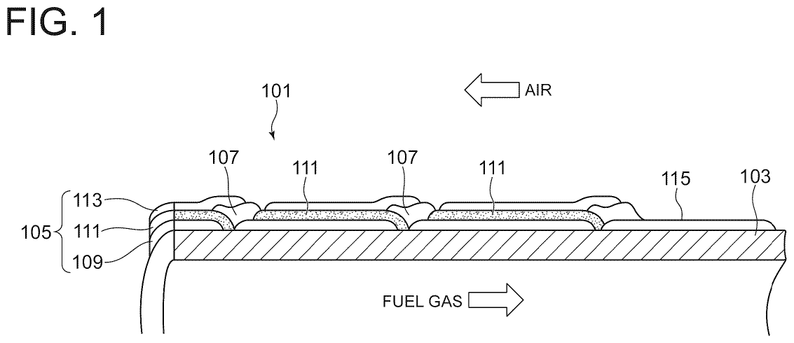

First, with reference to FIG. 1, a cylindrical cell stack using a substrate tube will be described as an example according to the present embodiment. In the case where the substrate tube is not used, for example, an anode may be formed thick to serve as the substrate tube; the embodiment is not limited to the use of the substrate tube. Further, although the present embodiment describes the substrate tube of cylindrical shape, the cross-section of the substrate tube is not necessarily limited to a circular shape; for example, it may be an elliptical shape as long as the substrate tube is tubular. The cell stack may be flat tubular in which the peripheral surface of the cylinder is vertically pressed. Here, FIG. 1 shows one aspect of a cell stack 101 according to an embodiment. The cell stack 101 includes a substrate tube 103 of cylindrical shape, for example, a plurality of electrochemical reaction cells 105 formed on the outer peripheral surface of the substrate tube 103, and an interconnector 107 formed between each adjacent electrochemical reaction cells 105. The electrochemical reaction cell 105 is formed by stacking an anode 109, an electrolyte 111, and a cathode 113. Further, the cell stack 101 includes a lead film 115 electrically connected via the interconnector 107 to the cathode 113 of the electrochemical reaction cell 105 formed at one end of the substrate tube 103 in the axial direction and a lead film 115 electrically connected to the anode 109 of the electrochemical reaction cell 105 formed at the other end in the axial direction of the substrate tube 103 among the plurality of electrochemical reaction cells 105 formed on the outer peripheral surface of the substrate tube 103.

The substrate tube 103 is made of a porous material, and is mainly composed of, for example, CaO-stabilized ZrO₂ (CSZ), a mixture of CSZ and nickel oxide (NiO) (CSZ+NiO), Y₂O₃-stabilized ZrO₂ (YSZ), or MgAl₂O₄. The substrate tube 103 supports the electrochemical reaction cells 105, the interconnectors 107, and the lead films 115, and diffuses fuel gas supplied to the inner peripheral surface of the substrate tube 103 to the anodes 109 formed on the outer peripheral surface of the substrate tube 103 through pores of the substrate tube 103.

The anode 109 is composed of an oxide of a composite material of Ni and zirconia-based electrolyte material, for example, Ni/YSZ. The anode 109 has a thickness of 50 μm to 250 μm, and the anode 109 may be formed by screen-printing slurry. In this case, in the anode 109, Ni, which is a component of the anode 109, has catalysis on the fuel gas. The catalysis is to cause the fuel gas supplied via the substrate tube 103, for example, a mixed gas of methane (CH₄) and steam to react to be reformed into hydrogen (H₂) and carbon monoxide (CO). Further, the anode 109 causes hydrogen (H₂) and carbon monoxide (CO) obtained by reforming to electrochemically react with oxygen ions (O₂) supplied via the electrolyte 111 in the vicinity of the interface with the electrolyte 111 to produce water (H₂O) and carbon dioxide (CO₂). The electrochemical reaction cell 105 generates power by electrons emitted from the oxygen ions at this time.

Examples of the fuel gas that can be supplied and used for the anode 109 of the electrochemical reaction cell include hydrogen (H₂), carbon monoxide (CO), hydrocarbon gas such as methane (CH₄), city gas, natural gas, and gasification gas produced from carbon-containing raw materials such as petroleum, methanol, and coal with a gasification facility.

As the electrolyte 111, YSZ is mainly used which has gas-tightness that makes it difficult for gas to pass through and high oxygen ion conductivity at high temperatures. The electrolyte 111 moves oxygen ions (O₂⁻) generated in the cathode to the anode. The electrolyte 111 disposed on the surface of the anode 109 has a film thickness of 10 μm to 100 μm. The electrolyte 111 may be formed by screen-printing slurry.

The cathode 113 is composed of, for example, a LaSrMnO₃-based oxide or a LaCoO₃-based oxide. The cathode 113 may be formed by screen printing slurry or applying slurry with a dispenser. The cathode 113 dissociates oxygen in the supplied oxidizing gas such as air in the vicinity of the interface with the electrolyte 111 to generate oxygen ions (O₂⁻).

The cathode 113 can have a two-layer structure. In this case, a cathode layer (cathode intermediate layer) closer to the electrolyte 111 is made of a material having high ionic conductivity and excellent catalytic activity. A cathode layer (cathode conductive layer) on the cathode intermediate layer may be composed of a perovskite oxide represented by Sr and Ca-doped LaMnO₃. Thus, it is possible to further improve power generation performance.

The oxidizing gas is a gas that contains about 15% to 30% oxygen, typically air is suitable, but other gases can also be used, such as a mixture of combustion flue gas and air, or a mixture of oxygen and air.

The interconnector 107 is composed of a conductive perovskite oxide represented by M₁₋ₓLₓTiO₃ (M is an alkaline earth metal element, and L is a lanthanoid element) such as SrTiO₃-based materials, and is formed by screen printing slurry. The interconnector 107 is composed of a dense film to prevent the mixing of the fuel gas and the oxidizing gas. Further, the interconnector 107 has stable durability and electrical conductivity under both an oxidizing atmosphere and a reducing atmosphere. The interconnector 107 electrically connects the cathode 113 of one of adjacent electrochemical reaction cells 105 and the anode 109 of the other electrochemical reaction cell 105 to connect the adjacent electrochemical reaction cells 105 in series.

The lead film 115 needs to have electronic conductivity and coefficient of thermal expansion close to that of other materials constituting the cell stack 101. For this reason, the lead film 115 is composed of a composite material of Ni and zirconia-based electrolyte material such as Ni/YSZ, or M₁₋ₓLₓTiO₃ (M is an alkaline earth metal element, and L is a lanthanoid element) such as SrTiO₃-based materials. The lead film 115 derives the DC power generated by the electrochemical reaction cells 105 connected in series by the interconnector 107 to near the end of the cell stack 101.

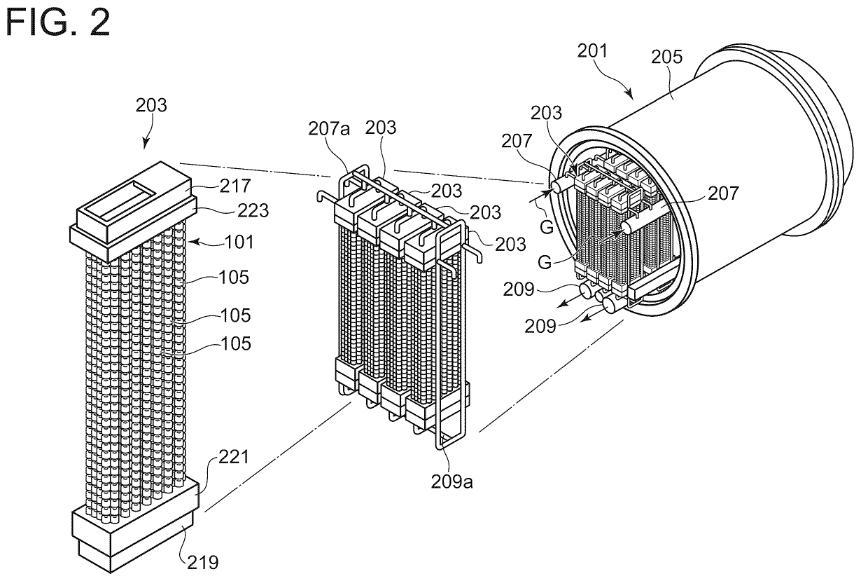

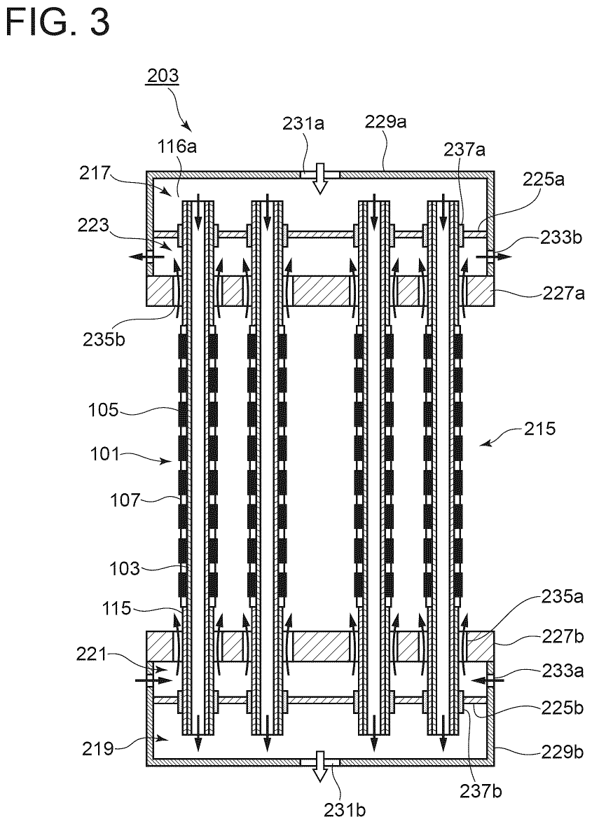

Next, with reference to FIGS. 2 and 3, an electrochemical reaction cell module and an electrochemical reaction cell cartridge according to an embodiment will be described. FIG. 2 shows one aspect of an electrochemical reaction cell module according to the present embodiment. FIG. 3 is a cross-sectional view of one aspect of an electrochemical reaction cell cartridge according to the present embodiment.

As shown in FIG. 2, an electrochemical reaction cell module 201 includes, for example, at least one electrochemical reaction cell cartridge 203 and a pressure vessel 205 for housing the at least one electrochemical reaction cell cartridge 203. The following describes the case where the electrochemical reaction cell module 201 includes a plurality of electrochemical reaction cell cartridges 203. Although FIG. 2 illustrates a cylindrical cell stack 101 of electrochemical reaction cells, this is not necessarily the case and, for example, a flat cell stack may be used. The electrochemical reaction cell module 201 includes a fuel gas supply pipe 207, a plurality of fuel gas supply branch pipes 207a, a fuel gas exhaust pipe 209, and a plurality of fuel gas exhaust branch pipes 209a. Further, the electrochemical reaction cell module 201 includes an oxidant supply pipe (not shown), oxidant supply branch pipes (not shown), an oxidant exhaust pipe (not shown), and oxidant exhaust branch pipes (not shown). The fuel gas supply pipe 207 is disposed outside the pressure vessel 205, is

connected to a fuel gas supply part for supplying fuel gas having a predetermined gas composition and a predetermined flow rate corresponding to the amount of power generated by the electrochemical reaction cell module 201, and is connected to the plurality of fuel gas supply branch pipes 207a. The fuel gas supply pipe 207 branches and distributes the fuel gas supplied from the fuel gas supply part at a predetermined flow rate to the plurality of fuel gas supply branch pipes 207a. The fuel gas supply branch pipes 207a are connected to the fuel gas supply pipe 207 and to the plurality of electrochemical reaction cell cartridges 203. The fuel gas supply branch pipes 207a introduce the fuel gas supplied from the fuel gas supply pipe 207 to the plurality of electrochemical reaction cell cartridges 203 at a substantially equal flow rate to substantially equalize the power generation performance of the plurality of electrochemical reaction cell cartridges 203.

The fuel gas exhaust branch pipes 209a are connected to the plurality of electrochemical reaction cell cartridges 203 and to the fuel gas exhaust pipe 209. The fuel gas exhaust branch pipes 209a introduce the exhaust fuel gas discharged from the electrochemical reaction cell cartridges 203 to the fuel gas exhaust pipe 209. The fuel gas exhaust pipe 209 is connected to the plurality of fuel gas exhaust branch pipes 209a and is partially disposed outside the pressure vessel 205. The fuel gas exhaust pipe 209 directs the exhaust fuel gas introduced from the fuel gas exhaust branch pipes 209a at a substantially equal flow rate to the outside of the pressure vessel 205.

Since the pressure vessel 205 is used at an internal pressure from 0.1 MPa to about 3 MPa and an internal temperature from atmospheric temperature to about 550° C., a material having high proof stress and corrosion resistance to an oxidizing agent such as oxygen contained in the oxidizing gas is used for the pressure vessel 205. For example, a stainless steel material such as SUS304 is preferable.

Here, the present embodiment describes the case where the electrochemical reaction cell cartridges 203 are assembled and housed in the pressure vessel 205, but the embodiment is not limited thereto. For example, the electrochemical reaction cell cartridges 203 may be housed in the pressure vessel 205 without being assembled.

As shown in FIG. 3, the electrochemical reaction cell cartridge 203 includes at least one cell stack 101, a power generation chamber 215, a fuel gas supply header 217, a fuel gas exhaust header 219, an oxidant (air) supply header 221, and an oxidant exhaust header 223. The following describes the case where the electrochemical reaction cell cartridge 203 includes a plurality of cell stacks 101. Further, the electrochemical reaction cell cartridge 203 includes an upper tube plate 225a, a lower tube plate 225b, an upper heat insulating body 227a, and a lower heat insulating body 227b. In the present embodiment, the fuel gas supply header 217, the fuel gas exhaust header 219, the oxidant supply header 221, and the oxidant exhaust header 223 are arranged as shown in FIG. 3, whereby the electrochemical reaction cell cartridge 203 has a structure such that the fuel gas and the oxidizing gas flow inside and outside the cell stack 101 in opposite directions, but this is not necessarily the case. For example, the fuel gas and the oxidizing gas may flow inside and outside the cell stack 101 in parallel, or the oxidizing gas may flow in a direction perpendicular to the longitudinal direction of the cell stack 101.

The power generation chamber 215 is a region formed between the upper heat insulating body 227a and the lower heat insulating body 227b. The power generation chamber 215 is a region where the electrochemical reaction cells 105 of the cell stacks 101 are arranged and where the fuel gas and the oxidizing gas electrochemically react to generate power. The temperature in the power generation chamber 215 near the center in the longitudinal direction of the cell stacks 101 is monitored by a temperature measuring part (e.g., temperature sensor or thermocouple) and becomes a high temperature atmosphere of approximately 700° C. to 1000° C. during the steady operation of the electrochemical reaction cell module 201.

The fuel gas supply header 217 is a region surrounded by an upper casing 229a of the electrochemical reaction cell cartridge 203 and the upper tube plate 225a, and communicates with the fuel gas supply branch pipe 207a through a fuel gas supply hole 231a provided in the upper portion of the upper casing 229a. Further, the cell stacks 101 are joined to the upper tube plate 225a with a seal material 237a. The fuel gas supply header 217 introduces the fuel gas supplied from the fuel gas supply branch pipe 207a through the fuel gas supply hole 231a into the substrate tubes 103 of the cell stacks 101 at a substantially uniform flow rate to substantially equalize the power generation performance of the plurality of cell stacks 101.

The fuel gas exhaust header 219 is a region surrounded by a lower casing 229b of the electrochemical reaction cell cartridge 203 and the lower tube plate 225b, and communicates with the fuel gas exhaust branch pipe 209a (not shown) through a fuel gas exhaust hole 231b provided in the lower casing 229b. Further, the cell stacks 101 are joined to the lower tube plate 225b with a seal material 237b. The fuel gas exhaust header 219 collects the exhaust fuel gas having passed through the substrate tubes 103 of the cell stacks 101 and supplied to the fuel gas exhaust header 219 and introduces it to the fuel gas exhaust branch pipe 209a through the fuel gas exhaust hole 231b.

The oxidizing gas having a predetermined gas composition and a predetermined flow rate is divided to the oxidizing gas supply branch pipes according to the amount of power generated by the electrochemical reaction cell module 201, and is supplied to the electrochemical reaction cell cartridges 203. The oxidant supply header 221 is a region surrounded by the lower casing 229b, the lower tube plate 225b, and the lower heat insulating body 227b of the electrochemical reaction cell cartridge 203, and communicates with the oxidant supply branch pipe (not shown) through oxidant supply holes 233a provided in the side surfaces of the lower casing 229b. The oxidant supply header 221 introduces the oxidizing gas supplied from the oxidant supply branch pipe (not shown) through the oxidant supply holes 233a at a predetermined flow rate to the power generation chamber 215 through oxidant supply gaps 235a, which will be described later.

The oxidant exhaust header 223 is a region surrounded by the upper casing 229a, the upper tube plate 225a, and the upper heat insulating body 227a of the electrochemical reaction cell cartridge 203, and communicates with the oxidant exhaust branch pipe (not shown) through oxidant exhaust holes 233b provided in the side surfaces of the upper casing 229a. The oxidant exhaust header 223 introduces the exhaust oxidizing gas supplied from the power generation chamber 215 to the oxidant exhaust header 223 through oxidant exhaust gaps 235b, which will be described later, to the oxidant exhaust branch pipe (not shown) through the oxidant exhaust holes 233b.

The upper tube plate 225a is fixed to the side plates of the upper casing 229a between the top plate of the upper casing 229a and the upper heat insulating body 227a such that the upper tube plate 225a, the top plate of the upper casing 229a, and the upper heat insulating body 227a are substantially parallel to each other. Further, the upper tube plate 225a has a plurality of holes corresponding to the number of cell stacks 101 disposed in the electrochemical reaction cell cartridge 203, and the cell stacks 101 are inserted into the corresponding holes. The upper tube plate 225a air-tightly supports one end portions of the cell stacks 101 via one or both of seal materials 237a and adhesive members, and separates the fuel gas supply header 217 from the oxidant exhaust header 223.

The upper heat insulating body 227a is disposed at a lower end portion of the upper casing 229a such that the upper heat insulating body 227a, the top plate of the upper casing 229a, and the upper tube plate 225a are substantially parallel to each other, and is fixed to the side plates of the upper casing 229a. Further, the upper heat insulating body 227a has a plurality of holes corresponding to the number of cell stacks 101 disposed in the electrochemical reaction cell cartridge 203. The diameter of each hole is set to be larger than the outer diameter of each cell stack 101. The upper heat insulating body 227a includes oxidant exhaust gaps 235b formed between the inner surface of each hole and the outer surface of each cell stack 101 inserted through the upper heat insulating body 227a.

The upper heat insulating body 227a separates the power generation chamber 215 from the oxidant exhaust header 223 and prevents the atmosphere around the upper tube plate 225a from becoming hot, suppressing a decrease in the strength and an increase in the corrosion due to the oxidizing agent contained in the oxidizing gas. Although the parts such as the upper tube plate 225a are made of a metal material having high temperature durability such as Inconel, it prevents the upper tube plate 225a from being exposed to high temperature in the power generation chamber 215 and increasing the temperature difference which may cause thermal deformation. Further, the upper heat insulating body 227a allows the oxidizing gas having passed through the power generation chamber 215 and exposed to high temperature to flow into the oxidant exhaust header 223 through the oxidant exhaust gaps 235b.

According to the present embodiment, with the structure of the electrochemical reaction cell cartridge 203, the fuel gas and the oxidizing gas flow inside and outside the cell stack 101 in opposite directions. The exhaust oxidizing gas thus exchanges heat with the fuel gas supplied to the power generation chamber 215 through the inside of the substrate tubes 103, so that the exhaust oxidizing gas is cooled to the extent that the upper tube plate 225a made of a metal material does not deform or buckle, and is supplied to the oxidant exhaust header 223. Further, the fuel gas is heated by heat exchange with the exhaust oxidizing gas discharged from the power generation chamber 215 and is supplied to the power generation chamber 215. As a result, the fuel gas preheated to a temperature suitable for power generation can be supplied to the power generation chamber 215 without a heater or the like.

The lower tube plate 225b is fixed to the side plates of the lower casing 229b between the bottom plate of the lower casing 229b and the lower heat insulating body 227b such that the lower tube plate 225b, the bottom plate of the lower casing 229b, and the lower heat insulating body 227b are substantially parallel to each other. Further, the lower tube plate 225b has a plurality of holes corresponding to the number of cell stacks 101 disposed in the electrochemical reaction cell cartridge 203, and the cell stacks 101 are inserted into the corresponding holes. The lower tube plate 225b air-tightly supports the other end portions of the cell stacks 101 via one or both of seal materials 237b and adhesive members, and separates the fuel gas exhaust header 219 from the oxidant supply header 221.

The lower heat insulating body 227b is disposed at an upper end portion of the lower casing 229b such that the lower heat insulating body 227b, the bottom plate of the lower casing 229b, and the lower tube plate 225b are substantially parallel to each other, and is fixed to the side plates of the lower casing 229b. Further, the lower heat insulating body 227b has a plurality of holes corresponding to the number of cell stacks 101 disposed in the electrochemical reaction cell cartridge 203. The diameter of each hole is set to be larger than the outer diameter of each cell stack 101. The lower heat insulating body 227b includes oxidant supply gaps 235a formed between the inner surface of each hole and the outer surface of each cell stack 101 inserted through the lower heat insulating body 227b.

The lower heat insulating body 227b separates the power generation chamber 215 from the oxidant supply header 221 and prevents the atmosphere around the lower tube plate 225b from becoming hot, suppressing a decrease in the strength and an increase in the corrosion due to the oxidizing agent contained in the oxidizing gas. Although the parts such as the lower tube plate 225b are made of a metal material having high temperature durability such as Inconel, it prevents the lower tube plate 225b from being exposed to high temperature and increasing the temperature difference which may cause thermal deformation. Further, the lower heat insulating body 227b allows the oxidizing gas supplied to the oxidant supply header 221 to flow into the power generation chamber 215 through the oxidant supply gaps 235a.

According to the present embodiment, with the structure of the electrochemical reaction cell cartridge 203, the fuel gas and the oxidizing gas flow inside and outside the cell stack 101 in opposite directions. The exhaust fuel gas passing the power generation chamber 215 through the inside of the substrate tubes 103 thus exchanges heat with the oxidizing gas supplied to the power generation chamber 215, so that the exhaust fuel gas is cooled to the extent that the lower tube plate 225b made of a metal material does not deform or buckle, and is supplied to the fuel gas exhaust header 219. Further, the oxidizing gas is heated by heat exchange with the exhaust fuel gas and is supplied to the power generation chamber 215. As a result, the oxidizing gas heated to a temperature required for power generation can be supplied to the power generation chamber 215 without a heater or the like.

The DC power generated in the power generation chamber 215 is directed to near the end of the cell stack 101 by the lead film 115 made of, for example, Ni/YSZ provided in the plurality of electrochemical reaction cells 105, and is then collected to a current collector rod (not shown) of the electrochemical reaction cell cartridge 203 via a current collector plate (not shown), and is taken out from each electrochemical reaction cell cartridge 203. A predetermined number of electrochemical reaction cell cartridges 203 are connected in series or parallel, and the DC power taken out from each electrochemical reaction cell cartridge 203 by the current collector rod is transferred to the outside of the electrochemical reaction cell module 201, converted into predetermined AC power with a power conversion device (e.g., inverter) of a power conditioner or the like (not shown), and supplied to a power supply destination (e.g., load facility or electric power system).

Next, the configuration of the seal materials 237a, 237b (hereinafter collectively referred to simply as “seal material 237”) will be described in detail. The seal material 237 includes a plurality of ceramic particles and a hardener for hardening the plurality of ceramic particles.

The ceramic particles are particulate materials consisting of sintered materials produced by heat treatment of inorganic materials, both metallic and non-metallic materials. In some embodiments, the ceramic particles include at least one of Al₂O₃, ZrO₂, ZrSiO₂, or MgO.

The hardener is a material for hardening the ceramic particles to form the seal material 117 as the molded product. In some embodiments, the hardener includes at least one of a cement-based hardener (e.g., Si—Ca—Al—O-based cement) or a phosphoric acid-based hardener.

When a phosphoric acid-based hardener is used as the hardener, the ceramic particles preferably include MgO. When MgO and the phosphoric acid-based hardener are mixed, magnesium phosphate is synthesized, and the ceramic particles can be suitably hardened by magnesium phosphate.

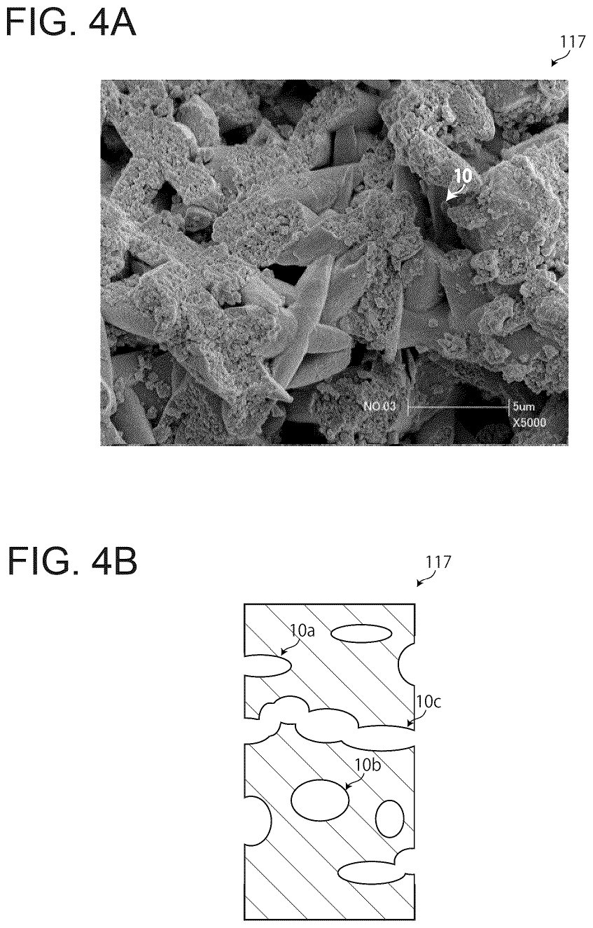

Thus, the seal material 237 has a configuration in which the ceramic particles are hardened by the hardener. FIG. 4A is an example of a microscopic image of the seal material 117. FIG. 4B is a schematic diagram schematically showing the internal structure of the seal material 117 shown in FIG. 4A. As shown in FIGS. 4A and 4B, the ceramic particles having a predetermined particle size are hardened by the hardener to form a microstructure with fine gaps 10 (open pores) between the ceramic particles. As shown in FIG. 4B, the gaps 10 include open pores 10a communicating with the outside and closed pores 10b not communicating with the outside (in FIG. 4B, through pores 10c that penetrate the seal material 117 are also shown as a form of the open pores 10a). The microstructure of the seal material 117 allows leakage through the gaps 10 while securing a sealing effect that does not cause performance degradation in the electrochemical reaction cell, thereby preventing the occurrence of damage to the seal material 237 even when a pressure difference occurs between the fuel gas and oxidizing gas.

The ceramic particles constituting the seal material 237 should not melt at the operating temperature (e.g., 600° C.) of the seal part of the electrochemical reaction cell. This allows the electrochemical reaction cell to suitably maintain the gaps 10 during operation.

As a result of the inventor's diligent research, it was found that the leak rate required for the seal material 237 is preferably in the range of 0.5 to 2.0% in order to both secure the performance of the electrochemical reaction cell and prevent damage to the seal material 237. The leak rate of the seal material 237 depends on the percentage of gaps 10, which are open pores in the seal material 237.

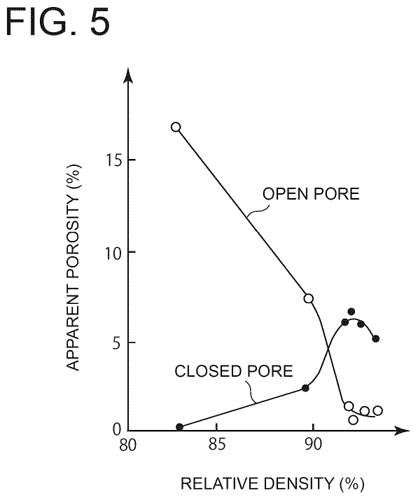

Here, FIG. 5 shows the correlation between the relative density of the seal material 237 and the porosity of open pores 10a and closed pores 10b. As shown in FIG. 5, the open pores 10a decrease sharply as the relative density of the seal material 237 increases, but at about 83% relative density, some of the voids that penetrate the seal material begin to be enclosed, so that the closed pores 10b tend to increase as the relative density increases.

In the following description, apparent porosity PA is used as the porosity related to the open pores 10a that penetrate the seal material. The apparent porosity PA herein is based on the JIS standard: test method for ceramic materials for electrical insulation (JIS C 2141-1992). The apparent porosity PA is determined as the percentage of the total volume of open pores 10a of the ceramic particles relative to the bulk volume, using the following expression.

PA(%)=(m3−m1)/(m3−m2)*100 (1)

In the expression, m1 is the dry weight of the test piece corresponding to the seal material 237 to be evaluated for the apparent porosity PA, m2 is the weight of the test piece suspended in water, and m3 is the weight of the test piece soaked.

The test pieces used to evaluate the apparent porosity PA are those with a weight of 5 g or more and that have had chipping removed prior to measurement (more specifically, samples formed into pellets according to the same procedure for producing the seal material 237 described below are used). The dry weight m1 is obtained by drying the test piece thus prepared in a thermostatic bath at 105 to 120° C., taking it out of the bath when reaching a constant weight, placing it in a desiccator, and weighing it on an instrument after reaching room temperature. The used weighing instrument has a sensitivity of 1 mg or more.

The weight m2 in water is obtained by weighing the suspended test piece prepared by immersing the test piece in water. The suspended test piece is obtained by the following procedure. The dried, constant-weight test piece is placed in a dry beaker, which is then placed in a vacuum vessel. The beaker is 200 ml or larger one as specified in JIS R 3503. The vacuum is held at 2 to 3*10³ Pa for 5 minutes. After holding, distilled water is added to the beaker in the vacuum vessel. After the test piece is completely immersed in distilled water, a vacuum is drawn for another 5 minutes, and then air is introduced to return the pressure to atmospheric.

The weight m3 of the soaked test piece is obtained by taking out the above-described suspended test piece from water, quickly wiping off water droplets on the surface with wet gauze, and weighing it. After the gauze is sufficiently soaked with water, it is squeezed to remove only water droplets on the surface of the test piece.

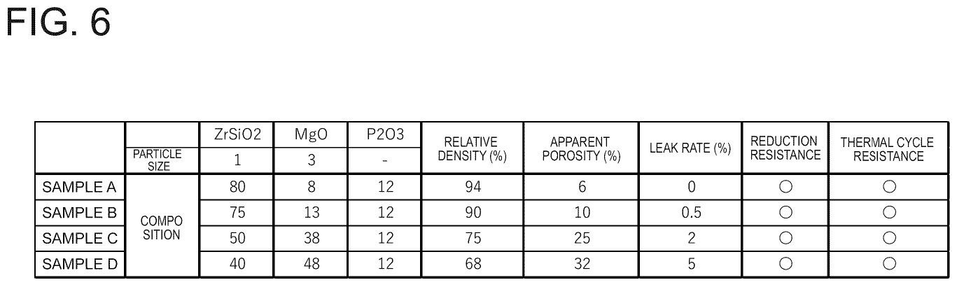

Using several samples A to D, we will discuss verification test results on the relationship between the composition ratio of materials used as the ceramic particles and the leak rate. FIG. 6 shows verification test results of samples A to D using ceramic particles with different composition ratios. In the verification test shown in FIG. 6, samples A to D were used, each of which contains ceramic particles, ZrSiO₂ and MgO, and a phosphoric acid-based hardener, P₂O₃, in a predetermined composition ratio. Specifically, the composition ratio of sample A is 80:8:12, sample B is 75:13:12, sample C is 50:38:12, and sample D is 40:48:12. The leak rate (%) shown in FIG. 6 was measured by the following leak rate

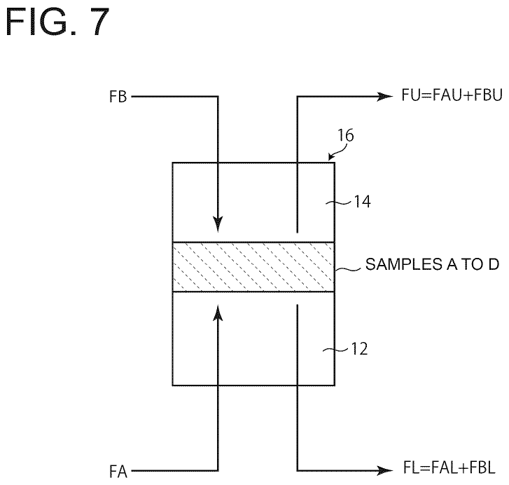

measurement test. FIG. 7 is an explanatory diagram of the leak rate measurement test. In this test, a diffusion cell 16 with a closed space divided into a first space 12 and a second space 14 by samples A to D was prepared (the diffusion cell 16 is maintained at a constant temperature T [K]). Fuel gas G_{A} was introduced into the first space 12 of the diffusion cell 16 at a molar flow rate of F_{A} [mol/s], and oxidizing gas G_{B} was introduced into the second space 14 at a molar flow rate of F_{B} [mol/s].

Since the first space 12 and the second space 14 are separated by samples A to D, each of which is a porous solid with a specific apparent porosity PA, the fuel gas G_{A} introduced into the first space 12 and the oxidizing gas G_{B} introduced into the second space 14 diffuse into each other, so that the mixed gas from the first space 12 flows out at molar flow rate F^{L} (=F_{A}^{L}+F_{B}^{L}) (composition based on mole fraction: y_{A}^{L}, y_{B}^{L}), and the mixed gas from the second space 14 flows out at molar flow rate F^{U} (=F_{A}^{U}+F_{B}^{U}) (composition based on mole fraction: y_{A}^{U}, y_{B}^{U}). Here, F_{A}^{L} is the molar flow rate occupied by the fuel gas G_{A} in the mixed gas flowing out of the first space 12, F_{B}^{L} is the molar flow rate occupied by the oxidizing gas G_{B} in the mixed gas flowing out of the first space 12, F_{A}^{U} is the molar flow rate occupied by the fuel gas G_{A} in the mixed gas flowing out of the second space 14, and F_{B}^{U} is the molar flow rate occupied by the oxidizing gas G_{B} in the mixed gas flowing out of the second space 14. In the leak rate measurement test, the leak rate is obtained by measuring the flow rates v^{U} [m³/s] and v^{L} [m³/s] of the mixed gas flowing out of the first space 12 and the second space 14, and simultaneously analyzing y_{A}^{L} and y_{B}^{U} by gas chromatography using the following expression.

Leak rate (%)=(y_{A}^{U}*100)/(y_{A}^{U}+y_{A}^{L}) (2)

According to the verification results shown in FIG. 6, sample A has a leak rate of 0%, which is smaller than the lower limit (0.5%) of the above range. The apparent porosity of sample A is 6%, which is also smaller than the lower limit (10%) of the above range in terms of apparent porosity. As in the aforementioned Patent Document 1, sample A is good when only the leakage performance is considered, but if a pressure difference occurs between the fuel gas and the oxidizing gas, the pressure difference can cause damage.

Sample B has a leak rate of 0.5%, which is included in the above range. The apparent porosity of sample B is 10%, which is also included in the above range in terms of apparent porosity. In sample B, a certain amount leakage is allowed while securing a sealing effect that does not cause performance degradation in the electrochemical reaction cell, thereby preventing the occurrence of damage to the seal material 237 even when a pressure difference occurs between the fuel gas and oxidizing gas.

Sample C has a leak rate of 2.0%, which is included in the above range. The apparent porosity of sample C is 25%, which is also included in the above range in terms of apparent porosity. In sample C, a certain amount leakage is allowed while securing a sealing effect that does not cause performance degradation in the electrochemical reaction cell, thereby preventing the occurrence of damage to the seal material 237 even when a pressure difference occurs between the fuel gas and oxidizing gas.

Sample D has a leak rate of 5.0%, which is larger than the upper limit (2.0%) of the above range. The apparent porosity of sample D is 32%, which is also larger than the upper limit (25%) of the above range in terms of apparent porosity. Sample D is good in that it allows leakage to prevent damage, but the mixing of the fuel gas and oxidizing gas is significant, and there is concern about the performance degradation of the electrochemical reaction cell.

Thus, the verification test shown in FIG. 6 experimentally verified that the leak rate of 0.5 to 2.0% (apparent porosity of 10 to 25%) in samples B and C enables both the leakage performance necessary to secure the performance of the electrochemical reaction cell and the prevention of damage due to a pressure difference.

Adjustment of the apparent porosity (or leak rate) in the seal material 237 may be made by selecting the particle size of the ceramic particles in the seal material 237. For example, the plurality of ceramic particles in the seal material 237 include different particle sizes. In this case, by appropriately selecting the particle size of the ceramic particles constituting the seal material 237, the apparent porosity (or leak rate) can be adjusted by changing the filling rate of the ceramic particles in a predetermined volume.

The seal material 237 may be composed of ceramic particles having a single particle size, as long as the apparent porosity (or leak rate) of the seal material 237 is within the above range.

Adjustment of the apparent porosity in the seal material 237 may be made by selecting the type of the ceramic particles in the seal material 237. For example, the plurality of ceramic particles in the seal material 237 include different types. In this case, by appropriately selecting the type of the ceramic particles constituting the seal material 237, the apparent porosity (or leak rate) can be adjusted by changing the filling rate of the ceramic particles in a predetermined volume.

The seal material 237 may be composed of ceramic particles of a single type, as long as the apparent porosity (or leak rate) of the seal material 237 is within the above range.

In the verification test shown in FIG. 6, samples A to D were also evaluated for reduction resistance and thermal cycle resistance. The reduction resistance was evaluated by exposing samples A to D to an atmosphere of fuel gas (H₂:N₂=60:40 (vol %)) for 10 hours at approximately 600° C., which is close to the operating temperature of the electrochemical reaction cell, and visually observing whether there were changes such as separation. According to the results, it was confirmed that good reduction resistance was obtained in all samples A to D. The thermal cycle resistance was evaluated by applying samples A to D onto YSZ pellets, repeating 10 cycles of temperature increase and decrease between room temperature and approximately 600° C., which is close to the operating temperature of the seal part of the electrochemical reaction cell, under an atmosphere of fuel gas (H₂:N₂=60:40 (vol %)), and visually observing whether there was separation from the YSZ pellets. According to the results, it was confirmed that good thermal cycle resistance was obtained in all samples A to D.

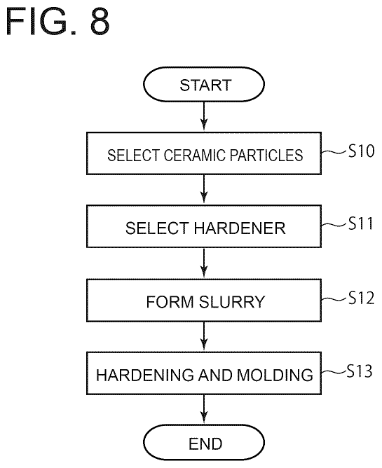

Next, the method of producing the seal material 237 having the above configuration will be described. FIG. 8 is a flowchart showing one aspect of the method of producing the seal material 237 according to the present embodiment.

First, ceramic particles, one of the components of the seal material 117, are selected (step S10). In the present embodiment, at least one of ceramic particle options, Al₂O₃, ZrO₂, ZrSiO₂, or MgO, is selected. As described above, when a phosphoric acid-based hardener is selected as the hardener in step S11, the ceramic particles may be selected to include at least MgO in order to synthesize magnesium phosphate, which is advantageous for hardening when mixed with the phosphoric acid-based hardener.

Then, a hardener, the other component of the seal material 117, is selected (step S11). In the present embodiment, at least one of hardener options, a cement-based hardener (e.g., Si—Ca—Al—O-based cement) or a phosphoric acid-based hardener, is selected.

The selection of the ceramic particles and the hardener in steps S10 and S11 is made so that the apparent porosity of the seal material 237 produced by this production method is 10 to 25% (or leak rate is 0.5 to 2.0%). As described above, since the apparent porosity (or leak rate) of the seal material 237 depends on the particle size or type of the ceramic particles hardened by the hardener, the apparent porosity of the seal material 237 can be adjusted to 10 to 25% (or leak rate to 0.5 to 2.0%) by appropriately selecting the ceramic particles and the hardener.

Although FIG. 8 shows the case where step S11 is performed after step S10, step S11 may be performed prior to step S10, or steps S10 and S11 may be simultaneously performed. The ceramic particles selected in step S10 and the hardener selected in step S11 are then mixed to form slurry (step S12). The slurry is formed by mixing the selected ceramic particles and hardener in predetermined amounts. To illustrate a specific example, when

ZrSiO₂ and MgO are selected as the ceramic particles and H₃PO₄ (orthophosphoric acid) is selected as the hardener, they are mixed in predetermined amounts and immersed in alcohol. As a result, MgO reacts with H₃PO₄ to synthesize Mg₃(PO₄)₂ (magnesium phosphate). Then, the mixture is heated at, for example, 50° C., to volatilize the alcohol, and water is added to the resulting powder to produce slurry. The slurry is produced, for example, by adding 3 g of water per 10 g of the resulting powder.

The slurry produced in step S12 is then hardened and molded (step S13). The slurry is, for example, filled into a mold corresponding to the shape of the seal material 237 and hardened at a predetermined temperature over a predetermined period to complete the seal material 237.

When a cement-based hardener is selected as the hardener in step S11, the seal material 237 can be formed simply by mixing the cement-based hardener and ceramic particles with water in step S12 and hardening it at a predetermined temperature (e.g., room temperature) for a predetermined period, so the seal material 237 can be obtained in a simpler procedure.

Samples A to D used in the verification test in FIG. 6 were made by filling the slurry into a cylindrical mold with a diameter of 20 mm, hardening it through reaction at 80° C. for 24 hours, and cutting the material taken out of the mold into pellets 3 mm thick.

As described above, the present embodiment provides a seal material for an electrochemical reaction cell, an electrochemical reaction cell cartridge, and a method of producing a seal material for an electrochemical reaction cell whereby it is possible to effectively prevent the occurrence of damage while securing a good leak performance even when a pressure difference occurs between fuel gas and oxidizing gas.

In addition, the components in the above-described embodiments may be appropriately replaced with known components without departing from the spirit of the present disclosure, or the above-described embodiments may be appropriately combined.

The contents described in the above embodiments would be understood as follows, for instance.

(1) A seal material for an electrochemical reaction cell according to one aspect is a seal material for an electrochemical reaction cell for separating fuel gas and oxidizing gas in the electrochemical reaction cell. The seal material includes: a plurality of ceramic particles; and a hardener for hardening the plurality of ceramic particles, and has an apparent porosity of to 25%.

According to the above aspect (1), the seal material for separating fuel gas and oxidizing gas in the electrochemical reaction cell is configured by hardening the plurality of ceramic particles with the hardener. The apparent porosity of the seal material thus configured depends on the distribution state of the ceramic particles hardened with the hardener. In the present aspect, the seal material is configured to have an apparent porosity of 10 to 25%. As a result, the seal material allows leakage to the extent that the effect on the performance of the electrochemical reaction cell is reduced, and it is possible to prevent the occurrence of damage due to a pressure difference between the fuel gas and oxidizing gas while securing the required sealing performance.

(2) In another aspect, in the above aspect (1), the plurality of ceramic particles includes different particle sizes.

According to the above aspect (2), since the ceramic particles with different particle sizes are used to make up the seal material, it is possible to adjust the apparent porosity using the difference in particle sizes. As a result, the seal material with an apparent porosity of 10 to 25% can be suitably obtained.

(3) In another aspect, in the above aspect (1) or (2), the plurality of ceramic particles includes different types.

According to the above aspect (3), since the ceramic particles with different types are used to make up the seal material, it is possible to adjust the apparent porosity using the difference in types. As a result, the seal material with an apparent porosity of 10 to 25% can be suitably obtained.

(4) In another aspect, in any one of the above aspects (1) to (3), the plurality of ceramic particles includes at least one of Al₂O₃, ZrO₂, ZrSiO₂, or MgO.

According to the above aspect (4), since the ceramic particles including at least one of Al₂O₃, ZrO₂, ZrSiO₂, or MgO are used, the seal material with an apparent porosity of 10 to 25% can be suitably obtained.

(5) In another aspect, in any of the above (1) to (4), the hardener includes at least one of a Si—Ca—Al—O-based cement or a phosphoric acid-based hardener.

According to the above aspect (5), since the hardener including at least one of a Si—Ca—Al—O-based cement or a phosphoric acid-based hardener is used, the seal material with an apparent porosity of 10 to 25% can be suitably obtained.

(6) In another aspect, in any one of the above aspects (1) to (5), the plurality of ceramic particles includes MgO, and the hardener includes a phosphoric acid-based hardener.

According to the above aspect (6), MgO is used as the ceramic particles, and a phosphoric acid-based hardener is used as the hardener. When MgO and the phosphoric acid-based hardener are mixed, magnesium phosphate is synthesized, and the ceramic particles are hardened by magnesium phosphate. As a result, the seal material with an apparent porosity of 10 to 25% can be suitably obtained.

(7) In another aspect, in the above aspect (6), the plurality of ceramic particles further includes ZrSiO₂.

According to the above aspect (7), when a phosphoric acid-based hardener is used as the hardener, ZrSiO₂ is used together with MgO as the ceramic particles. By using these materials, it is possible to obtain the seal material excellent in reduction resistance and thermal cycle resistance.

(8) An electrochemical reaction cell cartridge according to one aspect includes: at least one electrochemical reaction cell stack including an electrochemical reaction cell; a current collector member for collecting power generated by the at least one electrochemical reaction cell stack; and a seal material for an electrochemical reaction cell according to any one of the above aspects (1) to (7). The seal material for an electrochemical reaction cell is disposed between a fuel gas passage and an oxidizing gas passage of the at least one electrochemical reaction cell stack.

According to the above aspect (8), the seal material having the above configuration is disposed to separate fuel gas and oxidizing gas in the electrochemical reaction cell cartridge. As a result, even when a pressure difference occurs between fuel gas and oxidizing gas separated by the seal material, it is possible to prevent damage to the seal material due to the pressure difference while securing a good sealing performance.

(9) A method of producing a seal material for an electrochemical reaction cell according to one aspect is a method of producing a seal material for an electrochemical reaction cell for separating fuel gas and oxidizing gas in the electrochemical reaction cell. The method includes a step of hardening a plurality of ceramic particles with a hardener so as to have an apparent porosity of 10 to 25%.

According to the above aspect (9), by hardening the plurality of ceramic particles with the hardener, the seal material with an apparent porosity of 10 to 25% can be suitably produced.

(10) In another aspect, in the above aspect (9), magnesium phosphate is synthesized as the hardener by mixing phosphoric acid with the plurality of ceramic particles including MgO.

According to the above aspect (10), by using magnesium phosphate synthesized by mixing phosphoric acid with the ceramic particles including MgO as the hardener to harden the ceramic particles, the seal material with an apparent porosity of 10 to 25% can be suitably produced.

(11) In another aspect, in the above aspect (9), the hardener is a cement-based hardener.

According to the above aspect (11), by hardening the ceramic particles with the cement-based hardener, the seal material with an apparent porosity of 10 to 25% can be easily produced.

### REFERENCE SIGNS LIST

10 Gap
12 First space
14 Second space
16 Diffusion cell
101 Cell stack
103 Substrate tube
105 Electrochemical reaction cell
107 Interconnector
109 Anode
111 Electrolyte
113 Cathode
115 Lead film
117 Seal material
201 Electrochemical reaction cell module
203 Electrochemical reaction cell cartridge
205 Pressure vessel
207 Fuel gas supply pipe
207a Fuel gas supply branch pipe
209 Fuel gas exhaust pipe
209a Fuel gas exhaust branch pipe
215 Power generation chamber
217 Fuel gas supply header
219 Fuel gas exhaust header
221 Oxidant supply header
223 Oxidant exhaust header
225a Upper tube plate
225b Lower tube plate
227a Upper heat insulating body
227b Lower heat insulating body
229a Upper casing
229b Lower casing
231a Fuel gas supply hole
231b Fuel gas exhaust hole
233a Oxidant supply hole
233b Oxidant exhaust hole
235a Oxidant supply gap
235b Oxidant exhaust gap

1. A seal material for an electrochemical reaction cell for separating fuel gas and oxidizing gas in the electrochemical reaction cell, comprising:
a plurality of ceramic particles; and
a hardener for hardening the plurality of ceramic particles,
wherein the seal material has an apparent porosity of 10 to 25%.

2. The seal material for an electrochemical reaction cell according to claim 1,
wherein the plurality of ceramic particles includes different particle sizes.

3. The seal material for an electrochemical reaction cell according to claim 1,
wherein the plurality of ceramic particles includes different types.

4. The seal material for an electrochemical reaction cell according to claim 1,
wherein the plurality of ceramic particles includes at least one of Al₂O₃, ZrO₂, ZrSiO₂, or MgO.

5. The seal material for an electrochemical reaction cell according to claim 1,
wherein the hardener includes at least one of a Si—Ca—Al—O-based cement or a phosphoric acid-based hardener.

6. The seal material for an electrochemical reaction cell according to claim 1,
wherein the plurality of ceramic particles includes MgO, and
wherein the hardener includes a phosphoric acid-based hardener.

7. The seal material for an electrochemical reaction cell according to claim 6,
wherein the plurality of ceramic particles further includes ZrSiO₂.

8. An electrochemical reaction cell cartridge, comprising:
at least one electrochemical reaction cell stack including an electrochemical reaction cell;
a current collector member for collecting power generated by the at least one electrochemical reaction cell stack; and
a seal material for an electrochemical reaction cell according to claim 1,
wherein the seal material for an electrochemical reaction cell is disposed between a fuel gas passage and an oxidizing gas passage of the at least one electrochemical reaction cell stack.

9. A method of producing a seal material for an electrochemical reaction cell for separating fuel gas and oxidizing gas in the electrochemical reaction cell, comprising
a step of hardening a plurality of ceramic particles with a hardener so as to have an apparent porosity of 10 to 25%.

10. The method of producing a seal material for an electrochemical reaction cell according to claim 9,
wherein magnesium phosphate is synthesized as the hardener by mixing phosphoric acid with the plurality of ceramic particles including MgO.

11. The method of producing a seal material for an electrochemical reaction cell according to claim 9,
wherein the hardener is a cement-based hardener.
